(19) United States
(12) Patent Application Publication
(10) Pub. No.: US 2009/0137209 A1
(43) Pub. Date: May 28, 2009

(54) Method and apparatus for wireless charging

(75) Inventor: Pang-Ruei Huang, Taipei (TW)

Correspondence Address: REED SMITH LLP, Suite 1400, 3110 Fairview Park Drive, Falls Church, VA, 22042, US

(73) Assignee: Compal Communications, Inc.

(21) Appl. No.: 12/292,657

(22) Filed: Nov. 24, 2008

(30) Foreign Application Priority Data
Nov. 23, 2007 (TW) 096144392

(51) Int. Cl. H04B 7/00

(52) U.S. Cl. 455/66.1

(57) ABSTRACT

The invention provides a wireless charging method. In the wireless charging method, when a handheld device enters a presupposed range, an identification code is wirelessly received from the handheld device. Afterward, whether the identification code is a presupposed identification code is judged. If the result of judgment is yes, then the handheld device is wirelessly charged. Once the handheld device leaves the presupposed range, the charging of the handheld device will be stopped.

### BACKGROUND OF THE INVENTION

1. Field of the Invention

The invention relates to a handheld device, and more particularly, to a wireless charging method and a wireless charging apparatus.

2. Description of the Prior Art

With the rapid growth of mobile communication technology, mobile phones have already become a necessary tool in our daily life. However, the mobile phones shown on the market presently still have some inconveniences for most users. For example, when a user wants to charge the mobile phone or use the mobile phone to transmit or receive data, a transmission line is needed. Although the user can wirelessly transmit data via Bluetooth, it is inconvenient for most users because complicated wireless identification procedures must be performed every time before transmitting data.

Currently, a charging apparatus for wirelessly charging the handheld device has already been made. However, this wireless charging apparatus has no function of managing the usage authority, meaning that the owner of the wireless charging apparatus can not effectively forbid others to use his/her wireless charging apparatus without his/her permission.

Therefore, the invention provides a wireless charging method and a wireless charging apparatus to solve the above-mentioned problems.

### SUMMARY OF THE INVENTION

The main scope of the invention is to provide a wireless charging method and a wireless charging apparatus. The method and the apparatus of the invention combine a fast and simple wireless identification procedure and wireless charging. Additionally, the wireless charging method and the wireless charging apparatus according to the invention can further comprise steps/functions of wireless data transmission to provide users a straight and convenient way to use.

A preferred embodiment according to the invention is a wireless charging method. When a handheld device enters a presupposed range, the method makes the handheld device to wirelessly receive an identification code. Then, the method judges whether the identification code is a presupposed identification code. If the judgment result is yes, then the method wirelessly charges the handheld device. Once the handheld device leaves the presupposed range, the method will stop charging the handheld device.

Another preferred embodiment according to the invention is a wireless charging apparatus. The wireless charging apparatus comprises a receiving module, an identifying module, and a charging module. When a handheld device enters a presupposed range, the receiving module wirelessly receives an identification code from the handheld device. The identifying module is used for judging whether the identification code is a presupposed identification code. If the judgment result of the identifying module is yes, the charging module will start to wirelessly charge the handheld device, and once the handheld device leaves the presupposed range, the charging module will stop charging the handheld device.

The advantage and spirit of the invention may be further understood by the following recitations together with the appended drawings.

### BRIEF DESCRIPTION OF THE APPENDED DRAWINGS

FIG. 1 shows a flowchart of the wireless charging method for a handheld device in the first embodiment according to the invention.

FIG. 2(A) and FIG. 2(B) show flowcharts of the wireless charging method of FIG. 1 further comprising a data transmission step or a data receiving step respectively.

FIG. 3 shows a functional block diagram of the wireless charging apparatus in the second embodiment according to the invention.

FIG. 4(A) shows a functional block diagram of the wireless charging apparatus of FIG. 3 further comprising a requesting module.

FIG. 4(B) shows a functional block diagram of the wireless charging apparatus of FIG. 3 further comprising a requesting module, a data transmitting module, and a data receiving module.

### DETAILED DESCRIPTION OF THE INVENTION

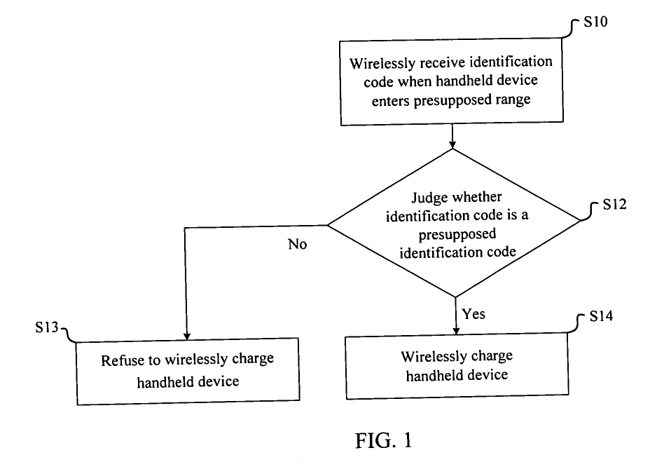

A first embodiment according to the invention is a wireless charging method for a handheld device. The handheld device can be a mobile phone, a personal digital assistant (PDA), or any other mobile communication apparatus. Please refer to FIG. 1. FIG. 1 shows a flowchart of the wireless charging method. As shown in FIG. 1, when a handheld device enters a presupposed range, the method firstly performs step S10 to make the handheld device to wirelessly receive an identification code. In fact, the handheld device can wirelessly receive the identification code through a radio frequency identification (RFID) way or a near field communication (NFC) way.

Then, the method performs step S12 to judge whether the identification code is a presupposed identification code. If the judgment result of step S12 is yes, the method performs step S14 to wirelessly charge the handheld device. Once the handheld device leaves the presupposed range, the method will stop charging the handheld device. Conversely, if the judgment result of step S12 is no, the method will perform step S13 to refuse to charge the handheld device.

In this embodiment, step S14 can be performed via a charging base. The charging base can be an ordinary socket, or coupled to a computer apparatus via a universal serial bus (USB) or an IEEE 1394 interface and powered by the computer apparatus.

In practical applications, a user can set up several sets of specific default identification codes on the charging base in advance. The charging base will start to wirelessly charge a handheld device only when the identification code of the handheld device matches one of these sets of specific default identification codes. By doing so, the owner of the charging base can effectively forbid others to use his/her charging base without his/her permission. Additionally, because the above-mentioned identification procedure can be automatically performed, users do not have to perform any complicated setup procedures at all.

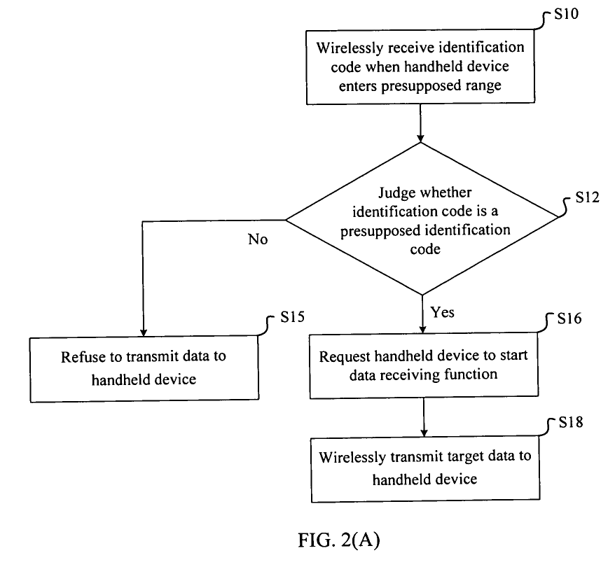

In this embodiment, the wireless charging method shown in FIG. 1 can further comprise a wireless data transmission step. As shown in FIG. 2(A), if the judgment result of step S12 is yes, then the method can perform step S16 to request the handheld device to start a data receiving function. After the handheld device starts the data receiving function, the method can perform step S18 to wirelessly transmit the target data to the handheld device. In fact, the target data can be in any form without limitation.

Generally, the effective wireless data transmission distance is larger than the effective wireless charging distance. Namely, the distance which data can be wirelessly transmitted is usually larger than that which the handheld device can be charged. Thus, even if the handheld device leaves the presupposed range, the handheld device can still receive the target data. For example, the target data can be transmitted to the handheld device in a Bluetooth communication protocol compatible way. If the judgment result of step S12 is no, then the method can perform step S15 to refuse to transmit data to the handheld device. It should be noted that although the Bluetooth communication protocol is used in the above-mentioned case, the handheld device can also receive data transmitted by other methods such as IrDA, WiFi, or WiMAX.

As shown in FIG. 2(B), if the judgment result of step S12 is yes, then the method can perform step S20 to request the handheld device to start a data transmitting function. Then, after the handheld device starts the data transmitting function, the method can perform step S22 to make the handheld device to wirelessly receive a target data. For example, the handheld device can transmit the target data in a Bluetooth communication protocol compatible way. Similarly, although the Bluetooth communication protocol is used in the above-mentioned case, the handheld device can also transmit data via other methods such as IrDA, WiFi, or WiMAX.

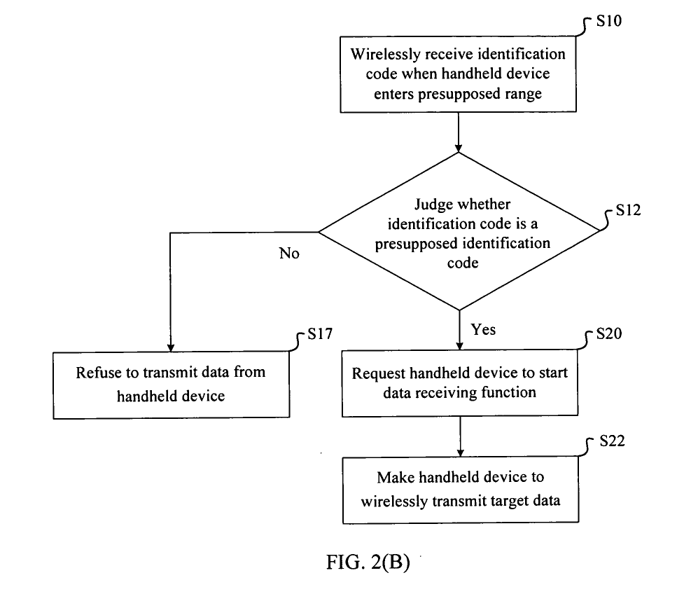

A second embodiment according to the invention is a wireless charging apparatus. Please refer to FIG. 3. FIG. 3 shows a functional block diagram of the wireless charging apparatus. As shown in FIG. 3, the wireless charging apparatus 20 comprises a receiving module 21, an identifying module 22, and a charging module 23. When a handheld device enters a presupposed range, the receiving module 21 wirelessly receives an identification code from the handheld device.

In fact, the size of the presupposed range is generally related to the features of the receiving module 21 and/or the charging module 23. The receiving module 21 can wirelessly receive the identification code through a radio frequency identification (RFID) way or a near field communication (NFC) way.

The identifying module 22 is used for judging whether the identification code is a presupposed identification code. If the judgment result of the identifying module 22 is yes, the charging module 23 will start to wirelessly charge the handheld device. Once the handheld device leaves the presupposed range, the charging module 23 will stop charging the handheld device. In fact, the charging module 23 can be coupled to a computer apparatus via a universal serial bus (USB) or an IEEE 1394 interface and powered by the computer apparatus.

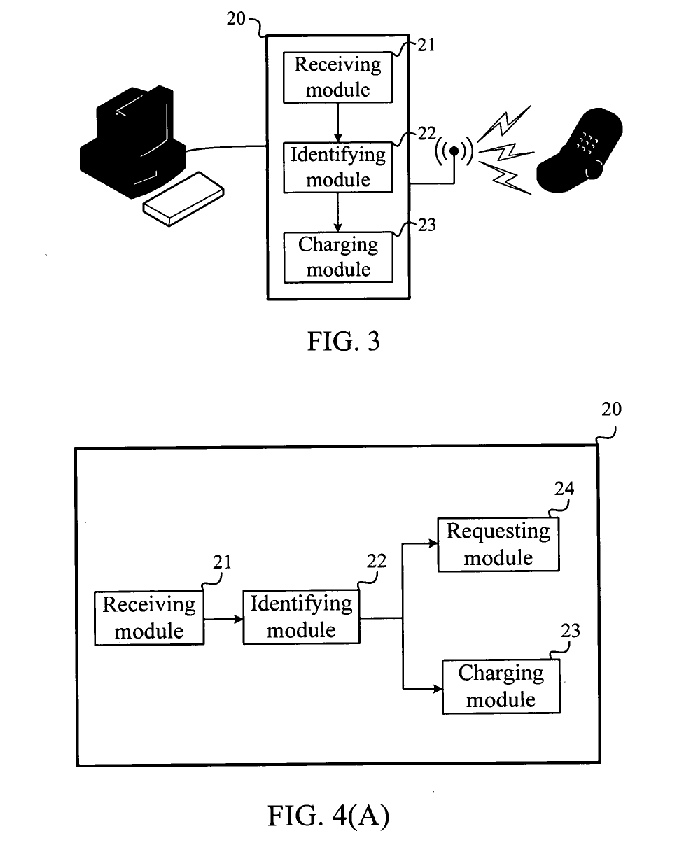

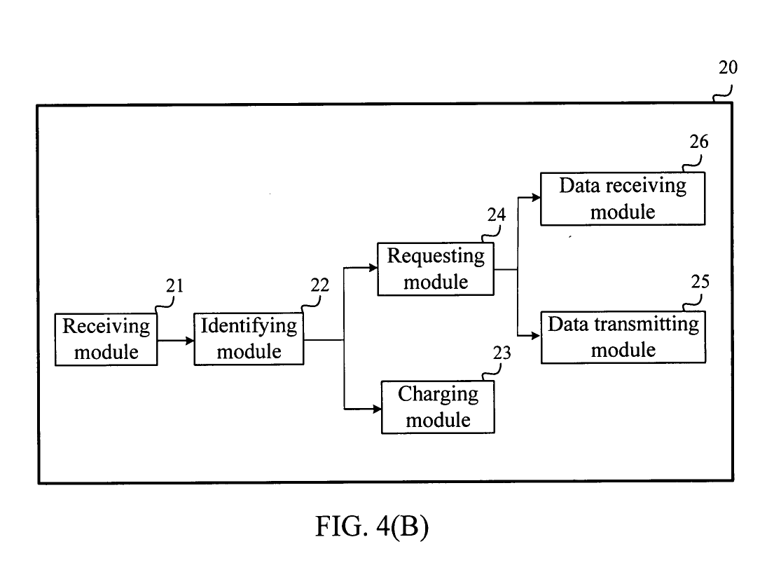

As shown in FIG. 4(A), the wireless charging apparatus 20 can further comprise a requesting module 24. If the judgment result of the identifying module 22 is yes, the requesting module 24 can request the handheld device to start a data transmitting function. After the handheld device starts the data transmitting function, the handheld device will wirelessly transmit the target data to the computer apparatus which provides power to the wireless charging apparatus 20. Additionally, even if the handheld device leaves the presupposed range, the handheld device can still wirelessly transmit the target data to the computer apparatus.

Moreover, if the judgment result of the identifying module 22 is yes, the requesting module 24 can also request the handheld device to start a data receiving function. After the handheld device starts the data receiving function, the wireless charging apparatus 20 will control the handheld device to receive a target data transmitted from the computer apparatus.

As shown in FIG. 4(B), the wireless charging apparatus 20 can further comprise the requesting module 24, a data transmitting module 25, and a data receiving module 26. If the judgment result of the identifying module 22 is yes, the requesting module 24 can request the handheld device to start a data transmitting function. After the handheld device starts the data transmitting function, the handheld device will wirelessly transmit a target data to the data receiving module 26 of the wireless charging apparatus 20.

Then, the data receiving module 26 will transmit the target data to the computer apparatus via a universal serial bus (USB) or an IEEE 1394 interface. The wireless charging apparatus 20 is coupled to the computer apparatus via the universal serial bus (USB) or the IEEE 1394 interface and powered by the computer apparatus. Additionally, even if the handheld device leaves the presupposed range of wireless charging, the handheld device can still transmit the target data to the data receiving module 26.

Moreover, if the judgment result of the identifying module 22 is yes, the requesting module 24 can also request the handheld device to start a data receiving function. After the handheld device starts the data receiving function, the data transmitting module 25 of the wireless charging apparatus 20 will transmit the target data to the handheld device.

Compared with the prior art, the wireless charging method and the wireless charging apparatus according to the invention combine a fast and simple wireless identification procedure and wireless charging. Additionally, the wireless charging method and the wireless charging apparatus can further comprise the wireless data transmission steps/functions to provide users a straight and convenient using way.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A wireless charging method, comprising the steps of:
(a) when a handheld device enters a presupposed range, the handheld device wirelessly receiving an identification code;
(b) judging whether the identification code is a presupposed identification code; and
(c) if the judgment result of step (b) is yes, wirelessly charging the handheld device, and once the handheld device leaves the presupposed range, stopping charging the handheld device.

2. The wireless charging method of claim 1, further comprising the steps of:
(d1) if the judgment result of step (b) is yes, requesting the handheld device to start a data receiving function; and
(d2) after the handheld device starts the data receiving function, wirelessly transmitting a target data to the handheld device.

3. The wireless charging method of claim 2, wherein even if the handheld device leaves the presupposed range, the handheld device can still receive the target data.

4. The wireless charging method of claim 2, wherein the target data is transmitted to the handheld device in a Bluetooth communication protocol compatible method.

5. The wireless charging method of claim 1, further comprising the steps of:
(d1) if the judgment result of step (b) is yes, requesting the handheld device to start a data transmitting function; and
(d2) after the handheld device starts the data transmitting function, the handheld device wirelessly receiving a target data.

6. The wireless charging method of claim 5, wherein even if the handheld device leaves the presupposed range, the handheld device can still transmit the target data.

7. The wireless charging method of claim 5, wherein the handheld device transmits the target data in a Bluetooth communication protocol compatible method.

8. The wireless charging method of claim 1, wherein in step (a), the handheld device wirelessly receives the identification code through a radio frequency identification (RFID) way or a near field communication (NFC) way.

9. The wireless charging method of claim 1, wherein step (c) is performed by a charging base, the charging base is coupled to a computer apparatus and powered by the computer apparatus.

10. The wireless charging method of claim 9, wherein the charging base is coupled to the computer apparatus via a universal serial bus (USB) or an IEEE 1394 interface and powered by the computer apparatus.

11. A wireless charging apparatus, comprising:
a receiving module, for wirelessly receiving an identification code from a handheld device when the handheld device enters a presupposed range;
an identifying module, coupled to the receiving module, for judging whether the identification code is a presupposed identification code; and
a charging module, coupled to the identifying module, if the judgment result of the identifying module is yes, the charging module starting to wirelessly charge the handheld device, and once the handheld device leaves the presupposed range, the charging module stopping charging the handheld device.

12. The wireless charging apparatus of claim 11, further comprising:
a requesting module, coupled to the identifying module, if the judgment result of the identifying module is yes, the requesting module requesting the handheld device to start a data transmitting function or a data receiving function.

13. The wireless charging apparatus of claim 12, further comprising:
a data transmitting module, coupled to the requesting module, after the handheld device starts the data receiving function, the data transmitting module wirelessly transmitting a target data to the handheld device.

14. The wireless charging apparatus of claim 13, further comprising:
a data receiving module, coupled to the requesting module, after the handheld device starts the data transmitting function, the data receiving module wirelessly receiving a target data from the handheld device.

15. The wireless charging apparatus of claim 13, wherein even if the handheld device leaves the presupposed range, the data transmitting module can still wirelessly transmit the target data to the handheld device.

16. The wireless charging apparatus of claim 14, wherein even if the handheld device leaves the presupposed range, the data receiving module can still wirelessly receive the target data from the handheld device.

17. The wireless charging apparatus of claim 13, wherein the data transmitting module transmits the target data to the handheld device in a Bluetooth communication protocol compatible way.

18. The wireless charging apparatus of claim 14, wherein the data receiving module receives the target data from the handheld device in a Bluetooth communication protocol compatible method.

19. The wireless charging apparatus of claim 11, wherein the receiving module wirelessly receives the identification code through a radio frequency identification (RFID) way or a near field communication (NFC) way.

20. The wireless charging apparatus of claim 11, wherein the charging module is coupled to a computer apparatus and powered by the computer apparatus.

21. The wireless charging apparatus of claim 20, wherein the charging module is coupled to a computer apparatus via a universal serial bus (USB) or an IEEE 1394 interface and powered by the computer apparatus.
